(19) United States
(12) Patent Application Publication
(10) Pub. No.: US 2011/0110649 A1
(43) Pub. Date: May 12, 2011

(54) ADAPTIVE VIDEO KEY FRAME SELECTION

(75) Inventor: Ying Luo, Stevenson Ranch, CA (US)

(73) Assignee: Thomson Licensing

(21) Appl. No.: 12/737,130

(22) PCT Filed: Jun. 19, 2008
(86) PCT No.: PCT/US2008/007677

§ 371 Date: Dec. 10, 2010

(51) Int. Cl. H04N 5/783

(52) U.S. Cl. 386/343; 386/E05.003

(57) ABSTRACT

A method and system are provided for adaptive video key frame selection. The system includes a range determination device for selecting portions of a video sequence to be analyzed for video key frame selection at a specific time based on at least a video key frame computational cost estimate. Each of the portions encompasses a respective range of frames in the video sequence. The system further includes a localized optimization device for analyzing the portions of the video sequence to select video key frames therein utilizing a hybrid video key frame selection process that is based on heuristics and global optimization. At least one constraint relating to at least a computational capacity of the system is explicitly modeled in the hybrid video key frame selection process.

### TECHNICAL FIELD

The present principles relate generally to video processing and, more particularly, to a method and apparatus for adaptive video key frame selection.

### BACKGROUND

Video key frame selection plays a central role in video playing applications such as fast forwarding and rewinding. Video key frame selection is also the critical problem to be solved for video content summarization problems such as video skimming and browsing. With the advent of digital video, the fast forwarding and rewinding of video has been redefined. That is, typically, the users control the operation through a software tool and the users can forward and rewind in any speed they desire. A typical tool is a slider accompanying the video displaying window, through which the user can drag and pull to play the video forward and backward. In addition to pacing to the point of interest, the digital video also gives the user the ability to quickly browse through the video sequences to have an understanding on the contents in short time using the above operations. This ability comes from the fact that digital video can avoid the annoying artifacts existing in analog video forwarding and rewinding by selectively display digital video frames. This procedure is called video browsing. If the selected video frames are to be extracted and stored for further use, it is called video skimming. Video skimming is typically used as the first step of video content analysis and video database indexing. The problem here is how to select the digital video frames in the above applications. It is the so-called video key frame selection problem, which is defined as how to select the frames from digital video sequences to best represent the contents of the video.

Many solutions have been proposed to solve this problem. All the solutions can be categorized into two approaches. The first approach is shown in FIG. 1 and the second approach is shown in FIG. 2. Turning to FIG. 1, a heuristics based approach to the video key frame selection problem is indicated generally by the reference numeral 100. The heuristics based approach 100 considers only neighboring frames. Turning to FIG. 2, a global optimization based approach to the video key frame selection problem is indicated generally by the reference numeral 200. The global optimization based approach 200 considers all frames. In FIGS. 1 and 2, the x-axis denotes the frames that are analyzed at a given time by the respective approaches, and the y-axis denotes video frame features as expressed in numerical form. The content features are generally multidimensional vectors. Only one dimension is shown here for the purpose of illustration.

The first approach makes judgments on frame selection based on heuristics, such as thresholding on image feature differences between neighboring frames. The advantage of the first approach is that it is fast and suitable for online applications such as video streaming. The drawback of the first approach is there is no guarantee that the most representative frames are selected since only local (neighboring) information is used. The second approach of the two above mentioned approaches addresses the “best representation” problem by optimization techniques. Global optimization algorithms such as dynamic programming and greedy algorithms are used to find the most representative frames. The advantage of the second approach is that the best representations are guaranteed to be achieved or nearly achieved. The drawback of the second approach is that the complete video sequences have to be presented when the corresponding algorithm is applied. This is unfortunately not the case today in ever popular applications such as web video streaming, where the already received video is played while the remaining video data is streamed. The initial receipt of the new streaming video data will trigger the algorithm to start the calculation from the beginning of the video sequences in order to maintain global optimality. This simply makes the global optimization techniques infeasible for the majority of user interface applications such as the abovementioned fast forwarding and rewinding, not to mention the expensive computational costs associated with the global optimization where all the frames have to be considered for a typical 90 minute movie (which typically have approximately 105 frames). Thus, the second approach can only be used in offline applications such as video database indexing.

These two approaches represent the two extremes on the spectrum of solutions, the first approach with an emphasis on speed and the second approach with an emphasis on optimality. Both approaches are not adaptive.

### SUMMARY

According to an aspect of the present principles, a system is provided for adaptive video key frame selection. The system includes a range determination device for selecting portions of a video sequence to be analyzed for video key frame selection at a specific time based on at least a video key frame computational cost estimate. Each of the portions encompasses a respective range of frames in the video sequence. The system further includes a localized optimization device for analyzing the portions of the video sequence to select video key frames therein utilizing a hybrid video key frame selection process that is based on heuristics and global optimization. At least one constraint relating to at least a computational capacity of the system is explicitly modeled in the hybrid video key frame selection process.

According to another aspect of the present principles, a method is provided for adaptive video key frame selection. The method includes selecting portions of a video sequence to be analyzed for video key frame selection at a specific time based on at least a video key frame computational cost estimate. Each of the portions encompasses a respective range of frames in the video sequence. The method further includes analyzing the portions of the video sequence to select video key frames therein utilizing a hybrid video key frame selection process that is based on heuristics and global optimization. At least one constraint relating to at least a computational capacity of the system is explicitly modeled in the hybrid video key frame selection process.

These and other aspects, features and advantages of the present principles will become apparent from the following detailed description of exemplary embodiments, which is to be read in connection with the accompanying drawings.

### BRIEF DESCRIPTION OF THE DRAWINGS

The present principles may be better understood in accordance with the following exemplary figures, in which:

FIG. 1 is a diagram for a heuristics based approach to the video key frame selection problem, in accordance with the prior art;

FIG. 2 is a diagram for a global optimization based approach to the video key frame selection problem, in accordance with the prior art;

FIG. 3 is a diagram for a constrained optimization (i.e., localized optimization) based approach to the video key frame selection problem, in accordance with an embodiment of the present principles;

FIG. 4 is a block diagram for an exemplary localized optimization system for video key frame selection, in accordance with an embodiment of the present principles; and

FIG. 5 is a flow diagram for an exemplary method for adaptive video key frame selection, in accordance with an embodiment of the present principles.

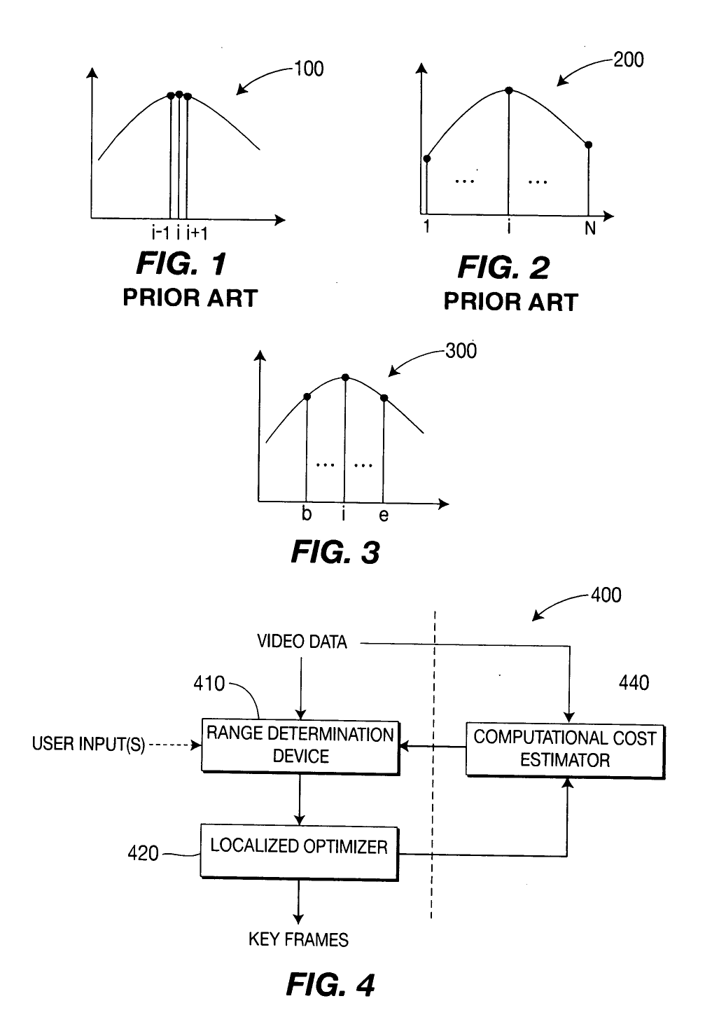

### DETAILED DESCRIPTION

The present principles are directed to a method and system for adaptive video key frame selection. The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor(s) to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment,” as well any other variations, appearing in various places throughout the specification are not necessarily all referring to the same embodiment.

It is to be appreciated that the use of the terms “and/or” and “at least one of,” for example, in the cases of “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C,” such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Advantageously, the present principles provide a video key frame selection framework that can be used to select key frames from video sequences. In accordance with one or more embodiments, the video key frame selection problem is reformulated into a localized optimization problem, where the key frame selection is maximally optimized within the constraints of user requirements and computational capacity of the platform. For example, in an embodiment, the user requirements and computational capacity of the platform are explicitly modeled into the optimization framework as constraints. This makes the framework adaptive to both computation intensive offline applications and online real time applications. Moreover, the maximal optimality is guaranteed within the constraints.

It is to be appreciated that the present principles are not limited to any particular user requirements. As an example, the user requirements can relate to a speed of a trick mode feature such as, for example, fast forwarding and rewinding. Of course, given the teachings of the present principles provided herein, one of ordinary skill in this and related arts will contemplate these and various other user requirements that can be utilized in accordance with the present principles, while maintaining the spirit of the present principles.

A description is now given of the problem to be addressed in accordance with one or more exemplary embodiments of the present principles.

Assume a digital video sequence S with time duration T. Altogether, there are N frames arranged in temporal sequential order numbered from 1 to N. The digital video sequence S can be represented as follows:

S={Fᵢ|1≦i≦N}}

where Fᵢ is the i^{th} frame. Frame Fₗ corresponds to time 0 and frame F_{N} corresponds to time T.

Generally, a feature vector Vᵢ is calculated for each frame. Frequently, features such as color and motion are chosen to represent the contents of the video frame. However, the algorithm designer can choose any features that are appropriate for the applications at hand.

Furthermore, a distance between feature vectors is also defined as follows:

Dᵢⱼ=d(Vᵢ,Vⱼ)

where Vᵢ and Vⱼ are the features vectors for frame i and j, respectively, d(,) is the distance metric that is used to measure the distance between two vectors in multidimensional feature space. Just like feature vector V, there are many choices for d(,) and the user can choose any distance metric that is appropriate. Dᵢⱼ is the computed distance between these two vectors, representing how much difference is between the frames i and j.

Again, the distances are chosen according to the application. Euclidean distance, Hamming distance and Mahanobis distance are frequent choices. However, other distance metrics can also be used, while maintaining the spirit of the present principles.

The task of video key frame selection is to identify a set of temporally ordered frames that best represent the contents of the video sequence S as follows:

s⊂S={Fᵢ|iε[1 . . . N]}

where Fᵢ are the key frames selected, and N is the total number of frames in the video.

The heuristics based approach and the global optimization based approach both start directly from this point.

For a typical heuristics based approach, starting from frame F₁, the distances between the feature vectors of neighboring frames are compared against a predefined threshold δ. If a distance is greater than δ, a critical change of video content is declared and the current video frame is selected to be a video key frame. The same procedure is repeated from frame F₁ to F_{N} to select a final set of key frames. This is a greedy approach without any optimality guaranteed.

In contrast to the heuristics based approach where only neighboring frames are considered, typical global optimization approaches such as dynamic programming consider all the frames from the beginning. In order to achieve global optimality, the optimization problem is sub-divided recursively into smaller optimization problems. The rational here is that the optimality of sub-problems will result in global optimization. Dynamic programming is an effective way to solve this problem. However, dynamic programming requires O(N³) computation, where N is the total number of frames in one video. This huge amount of computation makes dynamic programming inappropriate for online and real time applications.

In order to avoid the disadvantages of the two approaches and tailor the algorithm appropriately for online and real time applications, the video key frame selection problem is reformulated. Consider a specific time t in the video sequence, the key frame selection problem is solved for a time period T_{be} around t with an optimization technique. The beginning of the time period is t_{b}, while the ending of the time period is tₑ. Thus, the following:

T_{be}={t|t_{b}≦t≦tₑ} t_{b≧}0,tₑ≦T

where t represents time, and T represents the total time of a video clip.

Expressing the above equation in terms of the number of frames N_{be}, the following is found:

N_{be}={Fᵢ|b≦i≦e} b≧1,e≦N

where b is the frame corresponding to time t_{b}, e is the frame corresponding to time tₑ, i is the index for the frame, and N is the total number of frames, presuming the counting of frames starts from 1.

It can be seen that this formulation is a generalization from the previous formulations as follows. When b=i−1 and e=i+1, the formulation degenerates into the heuristic approach. When b=1 and e=N, the formulation degenerates into the global optimization approach. This is defined as a localized optimization approach, in that the optimization is performed in the duration of [t_{b} . . . tₑ] instead of [0 . . . T].

Turning to FIG. 3, a constrained optimization (i.e., localized optimization) based approach to the video key frame selection problem is indicated generally by the reference numeral 300. The localized optimization based approach 300 can be considered as a hybrid of the two previous approaches (i.e., the heuristics based approach and the global optimization based approach). In the localized optimization based approach 300, a group of local frames are considered (at a given time(s)). In FIG. 3, the x-axis denotes the frames that are analyzed at a given time by the local optimization approach, and the y-axis denotes video frame features as expressed in numerical form. The content features are generally multidimensional vectors. Only one dimension is shown here for the purpose of illustration.

A description is given regarding range determination for localized optimization in accordance with one or more exemplary embodiments of the present principles. The localized optimization may not always achieve the optimal result obtained by global optimization. However, the local optimization algorithm can be made to achieve the maximum possible optimality by adaptively choosing the range [b,e] of the local group of frames to be included in the computation at a specific time t.

There are three factors that directly affect the determination of [b,e]. The first factor is the allowed time for computation τ. The typical situation for this factor is in the fast forwarding case and/or the rewinding case, where the faster a user controls the slider, the less time is allowed for computation and vice versa. The second factor is the allowed computational power. A more powerful computer can process more frames in a given time. Although the computational power is determined by many factors such as CPU, memory and running environments, the million instructions per second (MIPS) of the processor is used to estimate the computational power of the platform, which is denoted as κ. Of course, other measures of processor speed and/or other measures relating to the computational power of the processor can be used with respect to the second factor, while maintaining the spirit of the present principles. The third factor is the size z of the video frame. Any computation involved, including feature and distance computation, are based on a computation on each pixel. Thus, the number of pixels, i.e., the size of the video frames, directly determines how much is computation is needed.

Assume the boundary b and e are symmetrical around the specific time t. Thus, N_{be} is essentially determined where:

N_{be}=ƒ(τ,κ,z)

Function ƒ(τ, κ, z) is determined based on the detailed algorithms used for optimization. Function ƒ(τ, κ, z) is designed in such a way that given an allowed computation time τ, an allowed computational power K and the size of the video frame, the function ƒ(τ, κ, z) yields the maximum number of frames for the optimization algorithm to achieve its maximal performance.

The optimization algorithm takes N_{be}/2 frames from both sides of the current frame i to perform optimization. In the case when the current frame i is near the boundaries of the video sequences, the chosen range of frames is shifted toward the other direction. For example, if i=N−4 and N_{be} is calculated to be 20, the range is shifted and the frames from [i−16,N] are chosen for optimization. Note here that the video sequence boundary may not necessarily be the beginning and end of the complete video sequence. When the video is streamed, the boundary can be the current latest frame streamed in the buffer.

Turning to FIG. 4, an exemplary localized optimization system for video key frame selection is indicated generally by the reference numeral 400. The system 400 includes a range determination device 410 having an output in signal communication with an input of a localized optimizer (also interchangeably referred to herein as “localized optimization device”) 420. A first output of the localized optimizer 420 is connected in signal communication with a first input of a computational cost estimator 440. An output of the computational cost estimator 440 is connected in signal communication with a first input of the range determination device 410.

A second input of the computational cost estimator 440 and a second input of the range determination device 410 are available as inputs of the system 400, for receiving video data. A third input of the range determination device 410 is available as an input of the system 400, for receiving a user input(s). A second output of the localized optimizer 420 is available as an output of the system 400, for outputting key frames.

In an embodiment, the optimization used by localized optimizer 420 can be independent and offline. That is, the optimization used by localized optimizer can be pre-selected and/or pre-configured. The computational cost can also be estimated offline (by the computational cost estimator 440) based on the optimization used by the localized optimizer 420. The estimated computational cost of optimization (as implemented by localized optimizer 420) together with the user input(s) is then fed into the range determination device 410. Finally, local optimization is performed (by localized optimizer 420) based on the determined range and optimization algorithm. The range determination and localized optimization can be either online or offline, dependent on the application requirement. The user input is application dependent and optional.

It is to be appreciated that the selection of elements and the corresponding arrangements thereof (e.g., connections (for example, one or more connections can be bi-directional instead of uni-directional, such as the connection from localized optimizer 420 to computational cost estimator 440, as well as many other possible variations), whether online/offline, and so forth) in system 400 is for illustrative purposes and, thus, other elements and other arrangements can also be implemented in accordance with the teachings of the present principles, while maintaining the spirit of the present principles.

It is to be appreciated that the optimization algorithm is independent of the system and, thus, the present principles are not limited to any particular optimization algorithm. Hence, the user can choose any algorithm that is appropriate for the application. Since computational cost will not be a problem through the range determination, global optimizations such as, for example, dynamic programming can be used.

A description is given of computational cost estimation in accordance with one or more exemplary embodiments of the present principles. The computational cost of every algorithm can be expressed as the computation complexity. For example, for the above-mentioned dynamic programming approach, the complexity is 0(N³), which mean that the computational time is proportional to N³, where N is the number of frames in a video sequence. However, the rough estimation of computational cost is not enough for this application. The cost needs to be more accurately estimated in order to determine the local range. A two-dimensional (2D) interpolation-extrapolation scheme is utilized to estimate the computational cost.

The computational cost is expressed in the average time needed to process a frame. The computational cost is denoted as Γ, where Γ is a function (g(,)) of video frame size z, and CPU computational power κ MIPS. Hence, Γ can be represented as follows:

Γ=g(z,κ)

It is generally infeasible to calculate the cost theoretically. Different video frame sizes, different video lengths, and a different computational platform are chosen to yield sparse empirical results. Then, a 2D coordinate system (z, κ) is set up. The empirical results are now points in this coordinate system. When there is a new platform, video frame size and input, Γ can be achieved by interpolation or extrapolation. It is to be appreciated that the present principles are not limited to any particular interpolation or extrapolation algorithm(s) and, thus, any interpolation and/or extrapolation algorithm(s) can be used in accordance with the teachings of the present principles, while maintaining the spirit of the present principles.

A description is given of range determination in accordance with one or more exemplary embodiments of the present principles. The average time to compute for one frame will be Γ given the above interpolation-extrapolation scheme. The number of frames N_{be} that can be included in the computation at a specific time t can be defined as follows:

$${N}_{be} = f ( r , κ , z ) = \frac{τ}{Γ} = \frac{τ}{g ( z , κ )}$$

In the above function for N_{be}, z is the inherent property of the video sequence, κ is the inherent property of the computational platform, and r is the requirement of the user.

For online applications such as fast forwarding and/or rewinding, τ is determined by the control of the user. If the length of the slider range is L, the video sequence number of frames is N, the user moves the slider at a pace of Δ per second, then τ is represented as follows:

$$τ = \frac{L}{N Δ}$$

For offline applications where the control of the user is not present, Δ can be considered to be 0 and τ can be considered to be ∞. In this case, b=1 and e=N, and the computation degenerates to global optimization.

A description is given of localized optimization in accordance with one or more exemplary embodiments of the present principles. The optimization is performed at a specific time t and key frames are found. Upon finishing the current computation, the system checks the current time t in the video sequence and performs optimization at that point again. This procedure repeats from the beginning of the video sequence until the end.

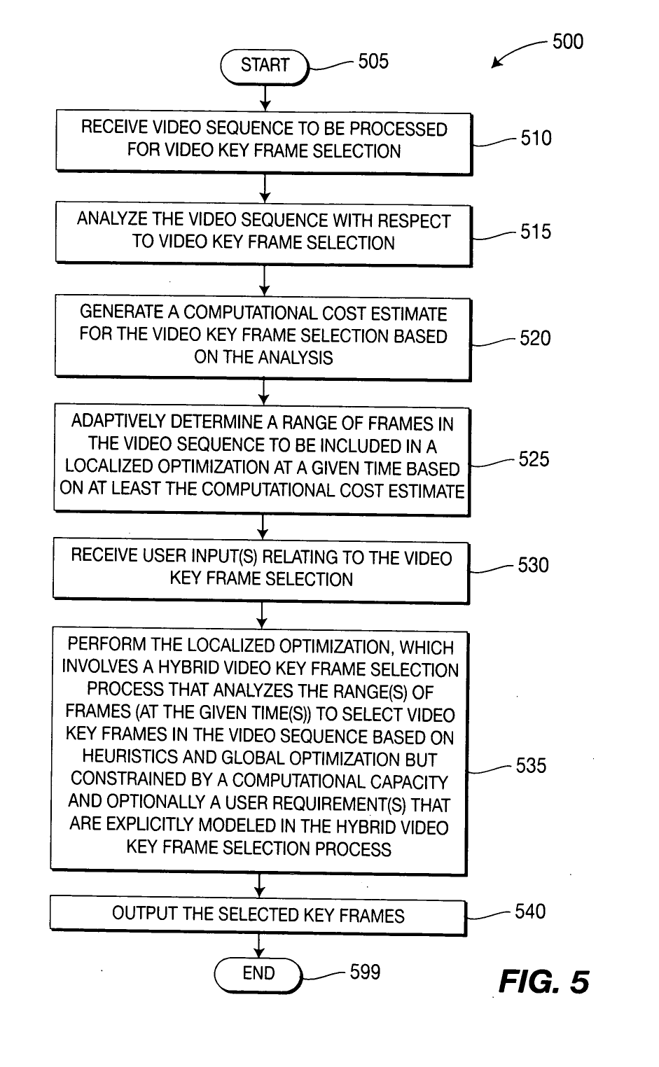

Turning to FIG. 5, an exemplary method for adaptive video key frame selection is indicated generally by the reference numeral 500. The method 500 includes a start block 505 that passes control to a function block 510. The function block 510 receives a video sequence to be processed for video key frame selection and passes control to a function block 515. The function block 515 analyzes the video sequence with respect to video key frame selection and passes control to a function block 520. The function block 520 generates a computational cost estimate for the video key frame selection based on the analysis performed with respect to function block 515 and passes control to a function block 525. The function block 525 adaptively determines a range of frames in the video sequence to be included in a localized optimization at a given time based on at least the computational cost estimate and passes control to a function block 530. The function block 530 receives a user input(s) relating to the video key frame selection and passes control to a function block 535. The function block 535 performs the local optimization, which involves a hybrid video key frame selection process that analyzes the range(s) of frames (at the given time(s)) to select video key frames in the video sequence based on heuristics and global optimization but constrained by a computational capacity and optionally a user requirement(s) that are explicitly modeled in the hybrid video key frame selection process and passes control to a function block 540. The function block 540 outputs the selected key frames and passes control to an end block 545.

These and other features and advantages of the present principles can be readily ascertained by one of ordinary skill in the pertinent art based on the teachings herein. It is to be understood that the teachings of the present principles can be implemented in various forms of hardware, software, firmware, special purpose processors, or combinations thereof.

Most preferably, the teachings of the present principles are implemented as a combination of hardware and software. Moreover, the software can be implemented as an application program tangibly embodied on a program storage unit. The application program can be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform can also include an operating system and microinstruction code. The various processes and functions described herein can be either part of the microinstruction code or part of the application program, or any combination thereof, which can be executed by a CPU. In addition, various other peripheral units can be connected to the computer platform such as an additional data storage unit and a printing unit.

It is to be further understood that, because some of the constituent system components and methods depicted in the accompanying drawings are preferably implemented in software, the actual connections between the system components or the process function blocks can differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles is not limited to those precise embodiments, and that various changes and modifications can be effected therein by one of ordinary skill in the pertinent art without departing from the scope or spirit of the present principles. All such changes and modifications are intended to be included within the scope of the present principles as set forth in the appended claims.

1. A system, comprising:
a range determination device that selects at least a portion of a video sequence to be analyzed for video key frame selection at a specific time based on at least a video key frame computational cost estimate, the portion encompassing a respective range of frames in the video sequence; and
an optimization device that analyzes the at least one portion of the video sequence to select video key frames therein utilizing a hybrid video key frame selection process that is based on heuristics and global optimization.

2. The system of claim 1, wherein at least one constraint relating to at least a computational capacity of the system is explicitly modeled in the hybrid video key frame selection process.

3. The system of claim 2, wherein the at least one constraint further relates to a user requirement that is also explicitly modeled in the hybrid video key frame selection process.

4. The system of claim 3, wherein the user requirement relates to a speed at which a user controls a trick mode function.

5. The system of claim 1, further comprising:
a computational cost estimator for generating the video key frame computational cost estimate.

6. The system of claim 1, wherein the hybrid video key frame selection process is configured to become a heuristics based video key frame selection process under a first set of conditions, and is configured to become a global optimization based video key frame selection process under a second set of conditions.

7. The system of claim 1, wherein said range determination device selects the range of the group of frames further based on at least one of an allowed time for computation and a video frame size.

8. The system of claim 1, wherein a particular one of the selected at least one portion spans an entirety of the video sequence.

9. The system of claim 1, wherein each of the at least one portion represents a set of frames in the video sequence that includes more than three members at a corresponding respective time.

10. The system of claim 1, wherein the selected at least one portion is analyzed by the hybrid video key frame selection process at any given time, including the specific time, encompass less than all of the frames of the video sequence but more than a particular frame and immediately neighboring frames of the particular frame.

11. The system of claim 1, wherein the video key frame computational cost estimate is generated based on at least one of interpolation and extrapolation performed with respect to a two-dimensional coordinate system.

12. A method, comprising the steps of:
selecting at least one portion of a video sequence to be analyzed for video key frame selection at a specific time based on at least a video key frame computational cost estimate, the portions encompassing a respective range of frames in the video sequence; and
analyzing the at least one portion of the video sequence to select video key frames therein utilizing a hybrid video key frame selection process that is based on heuristics and global optimization.

13. The method of claim 12, further comprising the step of
modeling at least one constraint relating to at least a computational capacity in the hybrid video key frame selection process.

14. The method of claim 13, further comprising the step of:
utilizing at least one constraint that further relates to a user requirement that is also modeled in the hybrid video key frame selection process.

15. The method of claim 14, further comprising the step of:
utilizing a user requirement that relates to a speed at which a user controls a trick mode function.

16. The method of claim 12, further comprising the step of:
generating the video key frame computational cost estimate.

17. The method of claim 12, further comprising the step of
utilizing a hybrid video key frame selection process that is configured to become a heuristics based video key frame selection process under a first set of conditions, and is configured to become a global optimization based video key frame selection process under a second set of conditions.

18. The method of claim 12, further comprising the step of:
utilizing a range of the group of frames that is selected further based on at least one of an allowed time for computation and a video frame size.

19. The method of claim 12, further comprising the step of:
utilizing a particular one of the selected at least one portion that spans an entirety of the video sequence.

20. The method of claim 12, further comprising the step of:
utilizing portions that represent a set of frames in the video sequence that includes more than three members at a corresponding respective time.

21. The method of claim 12, further comprising the step of:
utilizing selected at least one portion analyzed by the hybrid video key frame selection process at any given time, including the specific time, that encompass less than all of the frames of the video sequence but more than a particular frame and immediately neighboring frames of the particular frame.

22. The method of claim 12, further comprising the step of:
utilizing a video key frame computational cost estimate that is generated based on at least one of interpolation and extrapolation performed with respect to a two-dimensional coordinate system.

23. A computer program product comprising a computer readable medium having computer readable program code thereon for performing method steps for adaptive video key frame selection, the steps comprising:
selecting at least one portion of a video sequence to be analyzed for video key frame selection at a specific time based on at least a video key frame computational cost estimate, each of the portions encompassing a respective range of frames in the video sequence; and
analyzing the at least one portion of the video sequence to select video key frames therein utilizing a hybrid video key frame selection process that is based on heuristics and global optimization.

24. The computer program of claim 22, wherein at least one constraint relating to at least a computational capacity of the system is modeled in the hybrid video key frame selection process.
